(19) United States
(12) Patent Application Publication
(10) Pub. No.: US 2016/0124109 A1
(43) Pub. Date: May 5, 2016

(54) Semi-Analytic Inversion Method For Nuclear Magnetic Resonance (NMR) Signal Processing

(71) Applicant: Schlumberger Technology Corporation, Sugar Land, TX (US)

(72) Inventors: Can Evren Yarman, Cambridge (GB); Nicholas Heaton, Houston, TX (US); Lucas Monzon, Boulder, CO (US); Matthew Reynolds, Boulder, CO (US)

(21) Appl. No.: 14/896,459

(22) PCT Filed: Jun. 27, 2014
(86) PCT No.: PCT/US2014/044698

§ 371 Date: Dec. 7, 2015

Related U.S. Application Data
(60) Provisional application No. 61/841,393, filed on Jun. 30, 2013.

(51) Int. Cl. G01V 3/38; E21B 47/12; E21B 47/00; G01V 3/32; G01N 24/08

(52) U.S. Cl. CPC G01V 3/38; G01V 3/32; G01N 24/081; E21B 47/00; E21B 47/12

(57) ABSTRACT

The present disclosure provides a semi-analytic inversion method that computes an approximate, sparse representation of the data in terms of the (a, T₁, T₂). Methods, in accordance with the present disclosure, compute T2's in a semi-analytic fashion, such as by using simultaneous Hankel representation of the data, use one dimensional convex optimization to compute the amplitudes, a, and finally compute T₁ in an analytic fashion by appropriate averaging techniques. The proposed method provides a more efficient way to represent the data when compared to linearized methods, and is computationally less demanding when compared to some existing nonlinear optimization methods.

### CROSS-REFERENCE TO RELATED APPLICATION

This application claims priority from U.S. Provisional Patent Application 61/841,393, filed Jun. 30, 2013, which is incorporated herein by reference in its entirety.

### BACKGROUND

1. Technical Field

The present disclosure relates generally to nuclear magnetic resonance (NMR) logging and, more specifically, to techniques for processing NMR log data.

2. Background Information

This section is intended to introduce the reader to various aspects of art that may be related to various aspects of the subject matter described and/or claimed below. This discussion is believed to be helpful in providing the reader with background information to facilitate a better understanding of the various aspects of the present disclosure. Accordingly, it should be understood that these statements are to be read in this light, not as admissions of prior art.

Logging tools have long been used in wellbores to make, for example, formation evaluation measurements to infer properties of the formations surrounding the borehole and the fluids in the formations. Common logging tools include electromagnetic tools, nuclear tools, acoustic tools, and nuclear magnetic resonance (NMR) tools, though various other types of tools for evaluating formation properties are also available.

Early logging tools were run into a wellbore on a wireline cable after the wellbore had been drilled. Modern versions of such wireline tools are still used extensively. However, as the demand for information while drilling a borehole continued to increase, measurement-while-drilling (MWD) tools and logging-while-drilling (LWD) tools have since been developed. MWD tools typically provide drilling parameter information such as weight on the bit, torque, temperature, pressure, direction, and inclination. LWD tools typically provide formation evaluation measurements such as resistivity, porosity, NMR distributions, and so forth. MWD and LWD tools often have characteristics common to wireline tools (e.g., transmitting and receiving antennas, sensors, etc.), but MWD and LWD tools are designed and constructed to endure and operate in the harsh environment of drilling.

With respect to NMR logging, there has been increasing interest in providing additional formation evaluation data at the surface in real time, such as, for example, NMR echo train measurements. Using such measurements, NMR logging tools can indirectly measure the amount of hydrogen atoms in a formation, which can allow one to infer porosity and permeability characteristics about the formation. NMR measurements can also provide information concerning pore size, fluid typing, and fluid composition. In this regard, NMR tools are invaluable in accessing the quality, production planning and development of a reservoir.

To make these NMR measurements available at the surface in real time, compression algorithms may be used to convert the NMR data into a bit-stream that can be transmitted to the surface during while-drilling applications, using, for example, a mud-pulse telemetry system. While advancements in LWD NMR tool design and manufacturing improves reliability of real time NMR measurements, transmission of the raw measured or processed data from downhole to uphole is still limited by the telemetry bandwidth. In this regard, compression algorithms can be utilized to transmit either raw or processed echo trains and/or other petrophysical measurements that are derived from NMR measurements.

### SUMMARY

A summary of certain embodiments disclosed herein is set forth below. It should be understood that these aspects are presented merely to provide the reader with a brief summary of certain embodiments and that these aspects are not intended to limit the scope of this disclosure. Indeed, this disclosure may encompass a variety of aspects that may not be set forth in this section.

An inversion method is disclosed. In one embodiment, the method includes using a downhole nuclear magnetic resonance (NMR) measuring tool to obtain NMR measurements and computing a sparse representation of the NMR measurement data in terms of (a, T₁, T₂), where a represents amplitude of the NMR measurement data, T₁ represents longitudinal relaxation times, and T₂ represents transverse relaxation times.

In one embodiment, the method includes using a downhole nuclear magnetic resonance (NMR) measuring tool to obtain NMR measurements. a sparse representation of the NMR measurement data in terms of (a, T₁, T₂) are computed, where a represents amplitude of the NMR measurement data, T₁ represents longitudinal relaxation times, and T₂ represents transverse relaxation times. T₂ is computed using simultaneous Hankel representation of the NMR measurement data. a is computed using one-dimensional convex optimization. T₁ is computed using averaging.

In one embodiment, the method for inversion of nuclear magnetic resonance data includes estimating a T₂ distribution that simultaneously fits each sub-measurement, computing T₂ weights using convex optimization with constraints, computing coefficients aₘ using root finding and/or averaging, and computing a T₁ distribution in accordance with the following:

$$T {1}_{m , j}^{- 1} = {ln ( 1 - {w}_{j , m} / {a}_{m} )}^{- {WT}_{j}^{- 1}} T {1}_{m}^{- 1} = \frac{1}{N} {\sum }_{j = 1}^{J} T {1}_{m , j}^{- 1} .$$

Again, the brief summary presented above is intended to familiarize the reader with certain aspects and contexts of embodiments of the present disclosure without limitation to the claimed subject matter.

### BRIEF DESCRIPTION OF THE DRAWINGS

Certain embodiments of the invention will hereafter be described with reference to the accompanying drawings, wherein like reference numerals denote like elements, and:

FIG. 1 represents a schematic view of a well site system in which an embodiment of the present disclosure may be used.

FIG. 2 is a graphical representation of the result output of the logging method according to an embodiment of the disclosure.

FIG. 3 is a graphical representation of the result output of the logging method according to an embodiment of the disclosure.

FIG. 4 is a graphical representation of the result output of the logging method according to an embodiment of the disclosure.

### DETAILED DESCRIPTION

One or more specific embodiments of the present disclosure are described below. These embodiments are merely examples of the presently disclosed techniques. Additionally, in an effort to provide a concise description of these embodiments, all features of an actual implementation may not be described in the specification. It should be appreciated that in the development of any such implementation, as in any engineering or design project, numerous implementation-specific decisions are made to achieve the developers' specific goals, such as compliance with system-related and business-related constraints, which may vary from one implementation to another. Moreover, it should be appreciated that such development efforts might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The embodiments discussed below are intended to be examples that are illustrative in nature and should not be construed to mean that the specific embodiments described herein are necessarily preferential in nature. Additionally, it should be understood that references to “one embodiment” or “an embodiment” within the present disclosure are not to be interpreted as excluding the existence of additional embodiments that also incorporate the recited features.

As will be discussed further below, an inversion method for NMR log data has been developed. Considering the measurements obtained by Carr-Purcell-Meiboom-Gill (CPMG) echo decay trains (which are high dimensional and can include thousands of echoes), the presently disclosed methods may compute an optimal representation of the measurements that is sparse in T₂ and, consequently, T₁ relaxation times and amplitudes.

Linear inversion methods typically utilize logarithmically sampled T₂ and T₁ relaxation times and invert for corresponding amplitudes, a, to represent the data by solving a discretized inversion problem. The computed amplitudes are then compressed to be transmitted uphole. On the other hand, nonlinear optimization-based methods try to find a set of optimal (a, T₁, T₂)'s, which can be referred to as “triplets”, for the price of more computation time. Unlike current NMR data inversion methods, the presently disclosed methods do not assume a predefined T₁ and T₂ sampling and do not solve a large non-linear optimization problem.

The presently disclosed method is a semi-analytic inversion method that computes an approximate, sparse representation of the data in terms of the (a, T₁, T₂). To summarize, the disclosed method computes T₂'s in a semi-analytic fashion using simultaneous Hankel representation of the data, uses one dimensional convex optimization to compute the amplitudes, a, and finally computes T₁ in an analytic fashion by appropriate averaging techniques. The proposed method provides a more efficient way to represent the data when compared to linearized methods, and is computationally less demanding when compared to some existing nonlinear optimization methods.

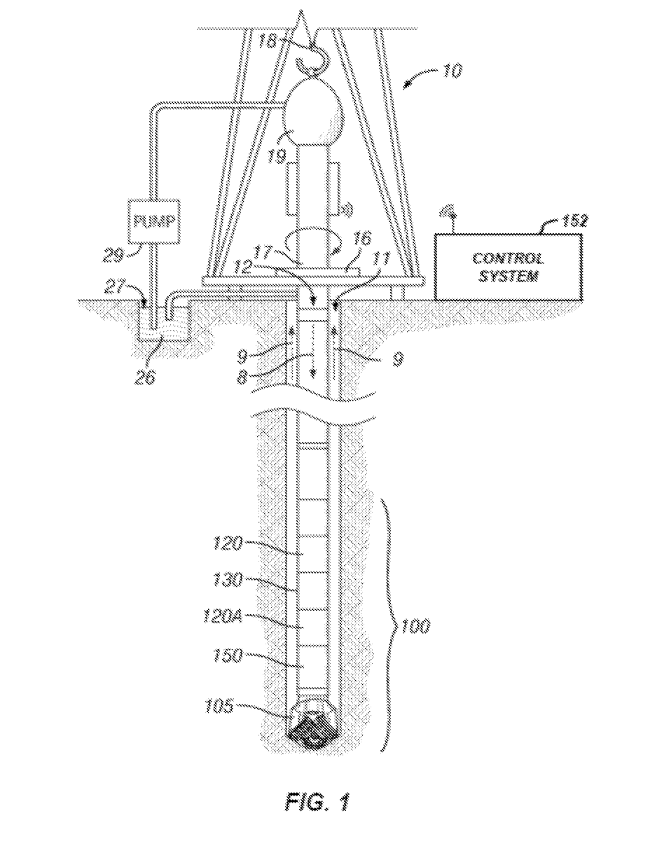

With the foregoing in mind, FIG. 1 (below) represents a simplified view of a well site system in which various embodiments can be employed. The well site system depicted in FIG. 1 can be deployed in either onshore or offshore applications. In this type of system, a borehole 11 is formed in subsurface formations by rotary drilling in a manner that is well known to those skilled in the art. Some embodiments can also use directional drilling.

A drill string 12 is suspended within the borehole 11 and has a BHA 100 which includes a drill bit 105 at its lower end. The surface system includes a platform and derrick assembly 10 positioned over the borehole 11, with the assembly 10 including a rotary table 16, kelly 17, hook 18 and rotary swivel 19. In a drilling operation, the drill string 12 is rotated by the rotary table 16 (energized by means not shown), which engages the kelly 17 at the upper end of the drill string. The drill string 12 is suspended from a hook 18, attached to a traveling block (also not shown), through the kelly 17 and a rotary swivel 19 which permits rotation of the drill string 12 relative to the hook 18. As is well known, a top drive system could be used in other embodiments.

Drilling fluid or mud 26 may be stored in a pit 27 formed at the well site. A pump 29 delivers the drilling fluid 26 to the interior of the drill string 12 via a port in the swivel 19, which causes the drilling fluid 26 to flow downwardly through the drill string 12, as indicated by the directional arrow 8 in FIG. 1. The drilling fluid exits the drill string 12 via ports in the drill bit 105, and then circulates upwardly through the annulus region between the outside of the drill string 12 and the wall of the borehole, as indicated by the directional arrows 9. In this known manner, the drilling fluid lubricates the drill bit 105 and carries formation cuttings up to the surface as it is returned to the pit 27 for recirculation.

The drill string 12 includes a BHA 100. In the illustrated embodiment, the BHA 100 is shown as having one MWD module 130 and multiple LWD modules 120 (with reference number 120A depicting a second LWD module 120). As used herein, the term “module” as applied to MWD and LWD devices is understood to mean either a single tool or a suite of multiple tools contained in a single modular device. Additionally, the BHA 100 includes a rotary steerable system (RSS) and motor 150 and a drill bit 105.

The LWD modules 120 may be housed in a drill collar and can include one or more types of logging tools. The LWD modules 120 may include capabilities for measuring, processing, and storing information, as well as for communicating with the surface equipment. By way of example, the LWD module 120 may include a nuclear magnetic resonance (NMR) logging tool, and may include capabilities for measuring, processing, and storing information, and for communicating with surface equipment.

The MWD module 130 is also housed in a drill collar, and can contain one or more devices for measuring characteristics of the drill string and drill bit. In the present embodiment, the MWD module 130 can include one or more of the following types of measuring devices: a weight-on-bit measuring device, a torque measuring device, a vibration measuring device, a shock measuring device, a stick/slip measuring device, a direction measuring device, and an inclination measuring device (the latter two sometimes being referred to collectively as a D&I package). The MWD tool 130 further includes an apparatus (not shown) for generating electrical power for the downhole system. For instance, power generated by the MWD tool 130 may be used to power the MWD tool 130 and the LWD tool(s) 120. In some embodiments, this apparatus may include a mud turbine generator powered by the flow of the drilling fluid 26. It is understood, however, that other power and/or battery systems may be employed.

The operation of the assembly 10 of FIG. 1 may be controlled using control system 152 located at the surface. The control system 152 may include one or more processor-based computing systems. In the present context, a processor may include a microprocessor, programmable logic devices (PLDs), field-gate programmable arrays (FPGAs), application-specific integrated circuits (ASICs), system-on-a-chip processors (SoCs), or any other suitable integrated circuit capable of executing encoded instructions stored, for example, on tangible computer-readable media (e.g., read-only memory, random access memory, a hard drive, optical disk, flash memory, etc.). Such instructions may correspond to, for instance, workflows and the like for carrying out a drilling operation, algorithms and routines for processing data received at the surface from the BHA 100, and so forth.

Before discussing the NMR inversion techniques of the present disclosure further, some background with respect to the operation of NMR logging tools is first provided. By way of background, NMR logging tools, i.e., LWD tool 120, may use permanent magnets to create a strong static magnetic polarizing field inside the formation. The hydrogen nuclei of water and hydrocarbons are electrically charged spinning protons that create weak magnetic field, similar to tiny bar magnets. When a strong external magnetic field from the logging tool passes through a formation containing fluids, these spinning protons align themselves like compass needles along the magnetic field. This process, called polarization, increases exponentially with a time constant, T₁, as long as the external magnetic field is applied. A magnetic pulse from the antenna rotates, or tips, the aligned protons into a plane perpendicular, or transverse, to the polarization field. These tipped protons immediately start to wobble or precess around the direction of the strong logging-tool magnetic field.

The precession frequency, called the Larmor frequency, is proportional to the strength of the external magnetic field. The precessing protons create an oscillating magnetic field, which generates weak radio signals at this frequency. The total signal amplitude from the precessing hydrogen nuclei (e.g., a few microvolts) is a measure of the total hydrogen content, or porosity, of the formation.

The rate at which the proton precession decays is called the transverse relaxation time, T₂, which reacts to the environment of the fluid—the pore-size distribution. T₂ measures the rate at which the spinning protons lose their alignment within the transverse plane. Typically, it can depend on three factors: the intrinsic bulk-relaxation rate in the fluid; the surface-relaxation rate, which is an environmental effect; and relaxation from diffusion in a polarized field gradient, which is a combination of environmental and tool effects. The spinning protons will quickly lose their relative phase alignment within the transverse plane because of variations in the static magnetic field. This process is called the free induction decay (FID), and the Carr-Purcell-Meiboom-Gill (CPMG) pulse-echo sequence is used to compensate for the rapid free-induction decay caused by reversible transverse dephasing effects.

The three components of the transverse relaxation decay play a significant role in the use of the T₂ distribution for well logging applications. For example, the intrinsic bulk relaxation decay time is caused principally by the magnetic interactions between neighboring spinning protons in the fluid molecules. These are often called spin-spin interactions. Molecular motion in water and light oil is rapid, so the relaxation is inefficient with correspondingly long decay-time constants. However, as liquids become more viscous, the molecular motion is slower. Then the magnetic fields, fluctuating due to their relative motion, approach the Larmor precession frequency, and the spin-spin magnetic relation interactions become much more efficient. Thus, tar and viscous oils can be identified because they relax relatively efficiently with shorter T₂ decay times than light oil or water.

Moreover, those skilled in the art will understand that fluids near, or in contact with, grain surfaces typically relax at a higher rate than the bulk fluid relaxation rate. Because of complex atomic level electromagnetic field interactions at the grain surface, there is a high probability that the spinning proton in the fluid will relax when it encounters a grain surface. For the surface relaxation process to dominate the decay time, the spinning protons in the fluid makes multiple encounters with the surface, caused by Brownian motion, across small pores in the formation. They repeatedly collide with the surface until a relaxation event occurs. The resulting T₂ distribution leads to a natural measure of the pore-size distribution.

### I. THE NMR INVERSION PROBLEM

As discussed above, NMR logging tools typically acquire CPMG echo decay trains. Given N multi-wait time measured echo trains, Mₙ, n=1; . . . , N, each consisting of Kₙ echoes, Mₙ(k), k=1, . . . , Kₙ, the NMR inversion problem addressed by the methods presented in this disclosure is finding a set of (aⱼ, T_{1,j}, T_{2,j}), aⱼT_{1,j}, T_{2,j}ε [symbol] ⁺, such that the error εₙ(k) in Equation (1) below is reduced or substantially minimized.

$${M}_{n} ( k ) = {\sum }_{j = 1}^{J} {a}_{j} {p}_{n , j} {e}^{- \frac{{kT}_{E}}{{T}_{2 , j}}} + {ε}_{n} ( k ) , \qquad ( 1 )$$

In Equation (1) above, aⱼ are the T₂ amplitudes, which are related with the partial porosity for the pores with T₂ relaxation times T_{2,j}, p_{n,j} are the polarization factor given by:

$${p}_{n , j} = ( 1 - {e}^{- \frac{{T}_{W , n}}{{T}_{1 , j}}} ) , \qquad ( 2 )$$

where T_{W,n} is the n-th wait-time, and T_{1,j} is the T₁ relaxation time associated with size of the pores which have T₂ relaxation times T_{2,j}, and T_{E} is the time sample between consecutive echoes, also referred to as the echo-spacing. Because the wait times T_{W,n} are positive and distinct, without loss of generality is assumed that they are ordered in decreasing order T_{W,1}>T_{W,2}> . . . >T_{W,N}.

With this in mind, the NMR inversion problem can be defined as an optimization problem which one can attempt to solve using linear or nonlinear methods. Unfortunately, regardless of which method chosen, the inversion problem is a highly redundant and ill-posed problem with non-unique solutions. This is why the problem is usually constrained by bounds on T₁ and T₂ relaxation times, assumption of logarithmically equally spaced T₁ and T₂ relaxation times, number of T₁ and T₂ relaxation time samples, and regularization factors that impose smoothness on the solution, which are not necessarily justified. In this regard, the presently disclosed method replaces the regularization constraints with a sparsity assumption of T₂ relaxation times, without assuming a predefined sampling grid.

### II. DESCRIPTION OF THE SEMI-ANALYTIC INVERSION FOR NMR DATA

In accordance with embodiments of the present disclosure, a semi-analytic inversion for NMR signal processing may include the following procedures: (1) estimating T_{2,j}, (2) estimating aⱼ, and (3) estimating T_{1,j}. These steps are described below.

### 1. Estimating T_{2,j}

The exponential fit of the form

$$\vert M ( k ) - {\sum }_{j = 1}^{J} {w}_{j} {γ}_{j}^{k} \vert < ε , k = 0 , … , K \qquad ( 3 )$$

with minimal number J<K of terms that obtains a desired error tolerance ε is governed by the singular value decay of the rectangular Hankel matrix M, whose elements are given by [M]_{m,l}=M (m+l), 0≦m≦K−L, 0≦l≦L≦K/2.

Two solutions to the exponential fit problem that utilize Hankel matrices are presented in References [11], [6] in Appendix A. Further, a more recent approach where the square Hankel matrix is considered is presented in References [2] and [3] in Appendix A. In general, the singular values of M decays exponentially, and one achieves error tolerance for J≦L<<K/2. As a result, an implicit reduction in the number of exponential terms required for representation of M(k) can be obtained.

While for fixed n, the forward model (1) can be expressed in the form of Equation (3), with wⱼ=aⱼp_{j,n} and

$${γ}_{j} = {e}^{- \frac{{T}_{E}}{{T}_{2 , j}}} ,$$

and the inversion problem provides determination of γⱼ's that can simultaneously fit Mₙ(k) for all n. In this regard, the Hankel matrix based exponential fit methods can be extended for simultaneous fitting of Mₙ(k) for all n. This is achieved by performing singular value decomposition of the matrix:

$$M = [ \begin{matrix}\frac{1}{\sqrt{{K}_{1} - L + 1}} {M}_{1} \\ \frac{1}{\sqrt{{K}_{2} - L + 1}} {M}_{2} \\ ⋮ \\ \frac{1}{\sqrt{{K}_{n} - L + 1}} {M}_{n}\end{matrix} ]$$

where Mₙ are Hankel matrices obtained from Mₙ, with [Mₙ]_{m,l}=Mₙ(m+l), 0≦l≦L≦minₙ{Kₙ}/2, 0≦j≦Kₙ−L. The singular values of M are related with the standard deviation of the errors εₙ, i.e., E[Σₙεₙ²]. For a chosen singular value, the roots of the polynomial whose coefficients are the entries of the right singular vector contains γⱼ's. It is noted that even though the coefficients of the polynomial are real, the polynomial may have complex roots. Due to the real positivity constraint on T_{2,j}, γⱼ can be set to be the roots that lie within the interval [0,1]. Thus one has J≦L.

### 2. Estimating aⱼ

Once γⱼ are obtained, a constrained non-negative least square problem is solved:

$${M}_{n} ( k ) \approx {\sum }_{j = 1}^{J} {w}_{n , j} {γ}_{j}^{k}$$

with the constraints w_{n,j}=aⱼp_{j,n}>0 and w_{n+1,j}<w_{n,j}, n=1, . . . , N−1. The latter constraint is due to the assumption on the ordering of wait times T_{W,1}>T_{W,2}> . . . >T_{W,N}.

Let T_{W,n+1}=βₙT_{W,n}, n=1, . . . , N−1, for some βₙ<1. As a result, there is:

$$1 - \frac{{w}_{n + 1 , j}}{{a}_{j}} = {( 1 - \frac{{w}_{n , j}}{{a}_{j}} )}^{{β}_{n}} \qquad ( 4 )$$

For a fixed n, using the notation a q_{n,j}=w_{n+1/j}/w_{n,j}ε(0,1), x_{n,j}=w_{n,j}/aⱼε(0,1), for n=1, . . . , N−1, and y_{n,j}=1−x_{n,j}ε(0,1), Equation (4) can be written as:

0=g(y_{n,j})=y_{n,j}^{βα}−q_{n,3}y_{n,j}+q_{n,j}−1 (5)

Thus, finding an optimal aⱼ is equivalent to finding the zeros of g(y_{n,j})=0. Since 0<βₙ<1, g(y_{n,j}) is a locally convex function with a maximum at

$${Y}_{n , j} = {( \frac{{β}_{n}}{{q}_{j}} )}^{\frac{1}{1 - {β}_{n}}} .$$

Furthermore, by the inequality:

$${β}_{n} = \frac{{T}_{W , n + 1}}{{T}_{W , n}} < \frac{{w}_{n + 1 , j}}{{w}_{n , j}} = {q}_{n , j} ,$$

and since g(0)=1 and g(1)=0, g has exactly one zero in (0, Y_{n,j}). Thus, for each n and j, Equation (4) above provides a unique solution x_{n,j}. Accordingly, aⱼ can be approximated by a weighted arithmetic mean:

$${a}_{j} \approx {\sum }_{n = 1}^{N - 1} \frac{{w}_{n , j}}{{x}_{n , j}} {P}_{a} ( n ) ,$$

for some probability measure Pₐ(n), which can be chosen based on the quality measurements Mₙ.

### 3. Estimating T_{1,j}

From w_{n,j}=aⱼp_{j,n}, one can obtain the following:

$$\frac{1}{{T}_{1 , j}} = - \frac{1}{{c}_{n}} ln ( 1 - \frac{{w}_{n , j}}{{a}_{j}} ) .$$

Since the average pore-radii of a permeable media is given by harmonic average of pore-radii where the average of T1 relaxation times is to be a harmonic average, one can approximate T_{1,j} by its weighted harmonic mean:

$${T}_{1 , j} = {[ {\sum }_{n = 1}^{N} - \frac{1}{{T}_{W , n}} ln ( 1 - \frac{{w}_{n , j}}{{a}_{j}} ) {P}_{{T}_{1}} ( n ) ]}^{- 1} ,$$

for some probability measure P_{T}_{₁}(n), which can be chosen based on the quality of the measurements Mₙ.
4. A Choice for Pₐ(n) and P_{T}_{₁}(n)

For long wait times, it can be seen from Equation (2) that p_{n,j}≈1. Therefore, w_{n,j}'s for longer wait times may provide better estimates for aⱼ. On the other hand, shorter wait times may provide better estimates for T_{1,j}'s. In this regard, in the numerical examples, uniform distribution has been chosen for Pₐ(n) and P_{T}_{₁}(n), defined over the appropriate indices, i.e.:

$${P}_{a} ( n ) = \frac{1}{{N}_{0}} {\sum }_{{n}_{0} = 1}^{{N}_{0}} {δ}_{n , {n}_{0}}$$

$${P}_{{T}_{1}} ( n ) = \frac{1}{N - {N}_{0}} {{\sum }^{N}}_{{n}_{0} = {N}_{0} + 1} {δ}_{n , {n}_{0}}$$

for some N₀<N where δ_{m,n}, which in one embodiment, is the Kronecker delta function, equal to one when m=n and equal to zero otherwise.

### III. EXAMPLES

### 1. Noise-Free Case

The method and technique described above was tested on a noise-free synthetic set of data using Equation (1) with εₙ(k)=0, for all n. The acquisition and measurement parameters are presented in Table I.

TABLE I
PARAMETERS USED TO GENERATE
THE SYNTHETIC DATA.
Measurement parameters

| j | aⱼ | Xⱼ = T_{1, j}/T_{2, j} | T_{2, j} (s) |
|---|---|---|---|
| 1 | 0.0411 | 1.25 | 0.0224 |
| 2 | 0.0412 | 1.25 | 0.0259 |
| 3 | 0.0391 | 1.25 | 0.0300 |
| 4 | 0.0011 | 2 | 1.1589 |
| 5 | 0.0260 | 2 | 1.3413 |

Acquisition parameters

| n | T_{W, n} (s) | T_{E} (ms) | Kₙ |
|---|---|---|---|
| 1 | 0.0 | 1 | 1000 |
| 2 | 3.0 | 1 | 1000 |
| 3 | 1.0 | 1 | 1000 |
| 4 | 0.3 | 1 | 300 |
| 5 | 0.1 | 1 | 100 |
| 6 | 0.03 | 1 | 30 |
| 7 | 0.01 | 1 | 10 |

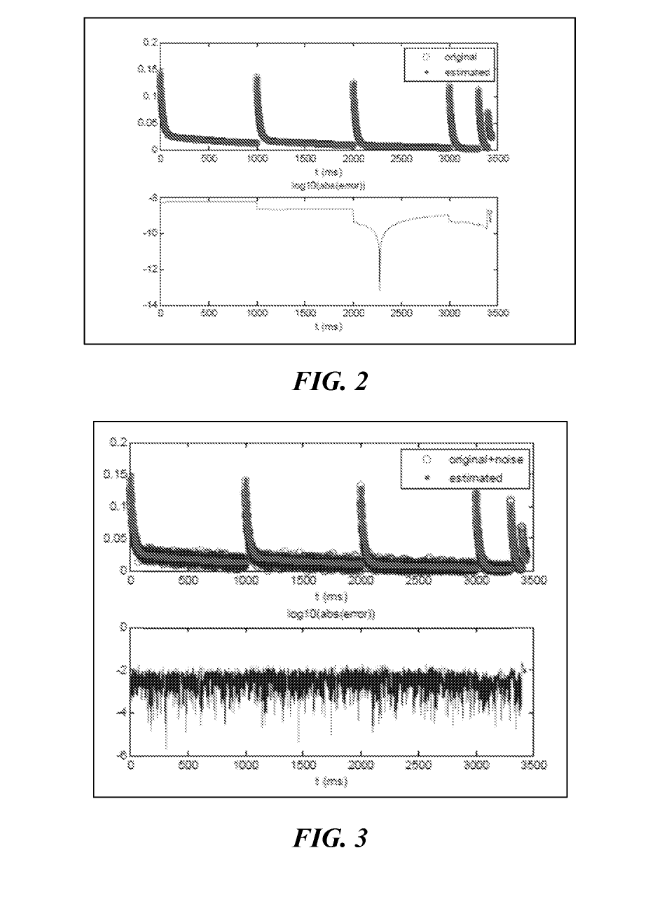

The generated data, its estimate obtained by the proposed method and the logarithm of the absolute error are presented in FIG. 2.

In FIG. 2, the upper graph shows the synthetic data (“original”) using the parameters in Table I, and the corresponding estimates using the proposed method (“estimated”). The lower graph shows the logarithm of the absolute error between the synthetic data and its estimate. As can be seen from FIG. 2, the absolute error in this example was found to be less than 10⁻⁸.

The relative errors of the estimated parameters are further presented in Table II below.

TABLE II
RELATIVE ERROR OF ESTIMATED PARAMETERS

| j | \|ãⱼ − aⱼ\|/aⱼ | \|\tilde{X}ⱼ − Xⱼ\|/Xⱼ | \|\tilde{T}_{2, j} − T_{2, j}\|/T_{2, j} |
|---|---|---|---|
| 1 | 6.9042 × 10⁻⁷ | 1.937 × 10⁻⁶ | 5.0104 × 10⁻⁸ |
| 2 | 1.4627 × 10⁻⁸ | 2.9483 × 10⁻⁶ | 2.7475 × 10⁻⁷ |
| 3 | 2.2767 × 10⁻⁶ | 1.2760 × 10⁻⁶ | 9.3993 × 10⁻⁸ |
| 4 | 9.3651 × 10⁻³ | 1.2843 × 10⁻⁴ | 6.4953 × 10⁻⁴ |
| 5 | 4.1239 × 10⁻³ | 6.3996 × 10⁻⁶ | 3.2651 × 10⁻⁵ |

### 2. Noisy Case

The method and technique described above was also tested on simulated noisy measurements by adding zero mean Gaussian white noise with a standard deviation of 0.005 to the noise-free synthetic data from FIG. 3. The simulated noisy measurement data, corresponding estimate of noise-free data and error, are presented in Table III and FIG. 3.

TABLE III
PARAMETERS ESTIMATED FROM NOISY VERSION OF
SYNTHETIC DATA PRESENTED IN FIG. 1.
Estimated parameters

| j | aⱼ | X_{J} = T_{1, j}/T_{2, j} | T_{2, j} |
|---|---|---|---|
| 1 | 0.1236 | 2.2184 | 0.0255 × 10³ |
| 2 | 0.0275 | 1.3973 | 1.3685 × 10³ |

From this table and figure, one can see that in the noisy case, the proposed method can compute an estimate for J=2 which lies within the noise level.

In FIG. 3, the upper graph shows synthetic noisy measurements (“original+noise”) and the estimated noise free data obtained using the disclosed method (“estimated”). The lower graph of FIG. 3 shows the logarithm of the absolute error between the synthetic noisy data and its estimate.

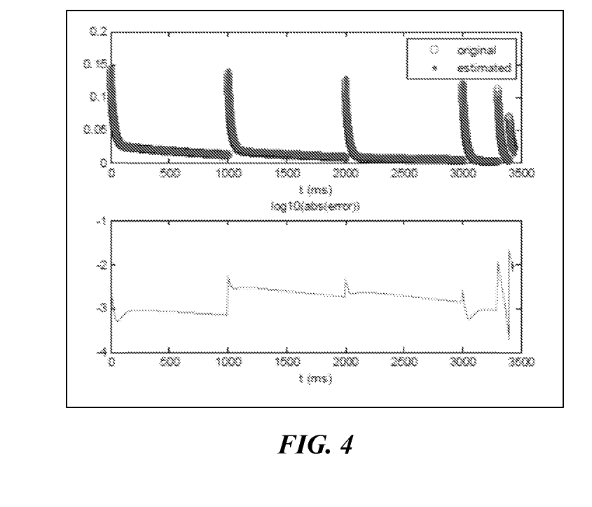

In FIG. 4, the estimated data obtained by applying the proposed method to the noisy data from FIG. 3 and the noise-free synthetic data from FIG. 2 is depicted.

The upper graph in FIG. 4 shows synthetic noise free data (“original”) and the estimated data obtained from noisy data using the disclosed method (“estimated”). The lower graph in FIG. 4 shows the logarithm of the absolute error between the synthetic noise free data and the estimated data.

It can be see that noise free synthetic data generated with J=5 can be expressed by J=2 parameters while staying within the noise level. Furthermore, when the porosity computed using the amplitudes of noise free synthetics is compared with the estimate obtained from noisy data, it was found that the relative error was less than 2% in this example, as shown in Table IV.

TABLE IV
RELATIVE POROSITY ERROR BETWEEN THE SYNTHETICS NOISE
FREE DATA AND ESTIMATED DATA OBTAINED FROM NOISY
DATA USING THE PROPOSED METHOD (SEE FIG. 3).

| | Noise free | | Relative porosity |
|---|---|---|---|
| Porosity | synthetic | estimated | error: |
| $Φ = {\sum }_{j = 1}^{J} {a}_{j}$ | Φ₀ = 0.1485 | Φ_{E} = 0.1511 | $\frac{\vert {Φ}_{B} - {Φ}_{0} \vert}{{Φ}_{0}} = 0.0175$ |

In practice, linearized inversion methods typically sample T2 relaxation times at 16 to 32 points and T1 relaxation times at 1 to 5 points. Thus, one needs to compress and transmit 16 to 160 amplitudes a uphole. In numerical experiments conducted using the presently disclosed methods, it was observed that at most 4, if not less, number of (a, T₁, T₂) triples were sufficient to form an estimate within the noise level, which means that when compared to existing linearized inversion methods, as little as 12 values need to be compressed and transmitted uphole.

Thus, compared to the best case scenario of linearized inversions (e.g., 16 amplitudes), at worst, the presently disclosed method still provides a 25 percent reduction in the number of values to be compressed and transmitted uphole.

As will be understood, the various techniques described above and relating to the processing of NMR measurements provided as example embodiments. Accordingly, it should be understood that the present disclosure should not be construed as being limited to only the examples provided above. Further, it should be appreciated that the NMR processing techniques disclosed herein may be implemented in any suitable manner, including hardware (suitably configured circuitry), software (e.g., via a computer program including executable code stored on one or more tangible computer readable medium), or via using a combination of both hardware and software elements.

While the specific embodiments described above have been shown by way of example, it will be appreciated that many modifications and other embodiments will come to the mind of one skilled in the art having the benefit of the teachings presented in the foregoing description and the associated drawings. Accordingly, it is understood that various modifications and embodiments are intended to be included within the scope of the appended claims.

What is claimed is:

1. A method comprising:
using a downhole nuclear magnetic resonance (NMR) measuring tool to obtain NMR measurements; and
computing a sparse representation of the NMR measurement data in terms of (a, T₁, T₂), wherein a represents amplitude of the NMR measurement data, T₁ represents longitudinal relaxation times, and T₂ represents transverse relaxation times.

2. The method of claim 1, comprising transmitting the sparse representation uphole using telemetry.

3. The method of claim 1, wherein T₂ is computed using simultaneous Hankel representation of the NMR measurement data.

4. The method of claim 1, wherein a is computed using one-dimensional convex optimization.

5. The method of claim 1, wherein T₁ is computed using averaging.

6. A method for inversion of nuclear magnetic resonance data as substantially described herein.

7. A system for inversion of nuclear magnetic resonance data that is configured to perform the method of claim 6.

8. A nuclear magnetic resonance logging tool that is adapted to perform the method of claim 6.

9. The nuclear magnetic resonance logging tool of claim 8, wherein the logging tool is a logging-while-drilling tool.

10. A method comprising:
using a downhole nuclear magnetic resonance (NMR) measuring tool to obtain NMR measurements; and
computing a sparse representation of the NMR measurement data in terms of (a, T₁, T₂), wherein a represents amplitude of the NMR measurement data, T₁ represents longitudinal relaxation times, and T₂ represents transverse relaxation times, wherein:
T₂ is computed using simultaneous Hankel representation of the NMR measurement data;
a is computed using one-dimensional convex optimization; and
T₁ is computed using averaging.

11. A method for inversion of nuclear magnetic resonance data comprising:
(a) for a plurality of “J” sub-measurements, estimating a T₂ distribution that simultaneously fits each sub-measurement, as expressed by:
$${M}_{j} ( k ) \approx {\sum }_{m} {e}^{- k TE / T {2}_{m}} {w}_{j , m} T {2}_{m}$$
(b) computing T₂ weights using convex optimization with constraints, as expressed by:
w_{1,m,}>w_{2,m}> . . . >w_{J,m}
w_{1,m}/WT₁<w_{2,m}/WT₂< . . . <w_{J,m}/WT_{J}
(c) computing coefficients aₘ using root finding and/or averaging, as expressed by:
$${w}_{j , m} = {a}_{m} ( 1 - {e}^{- {WT}_{i} / T {1}_{m}} ) {e}^{- {WT}_{j} / T {1}_{m}} = 1 - {w}_{j , m} / {a}_{m} > 0$$
$$1 - {w}_{j + 1 , m} / {a}_{m} = {( 1 - {w}_{j , m} / {a}_{m} )}^{{WT}_{j + 1} / {WT}_{j}} {a}_{m , j} \\ {a}_{m} = \frac{1}{J - 1} {\sum }_{j = 1}^{J - 1} {a}_{m , j} ;$$
and
(d) computing a T₁ distribution in accordance with the following:
$$T {1}_{m , j}^{- 1} = {ln ( 1 - {w}_{j , m} / {a}_{m} )}^{- {WT}_{j}^{- 1}} T {1}_{m}^{- 1} = \frac{1}{N} {\sum }_{j = 1}^{J} T {1}_{m , j}^{- 1} .$$
